(19) United States
(12) Patent Application Publication
(10) Pub. No.: US 2005/0043965 A1
(43) Pub. Date: Feb. 24, 2005

(54) Methods and apparatus for automated interactive medical management

(76) Inventors: Gabriel Heller, Toronto (CA); Stephen S. Rabinowitz, New York, NY (US)

Correspondence Address: KLAUBER & JACKSON, 411 HACKENSACK AVENUE, HACKENSACK, NJ, 07601, US

(21) Appl. No.: 10/497,127

(22) PCT Filed: Nov. 29, 2002
(86) PCT No.: PCT/US02/38432

Related U.S. Application Data
(60) Provisional application No. 60/333,837, filed on Nov. 28, 2001.

(51) Int. Cl. G06F 17/60; G06F 19/00

(52) U.S. Cl. 705/2; 700/245

(57) ABSTRACT

The present invention provides computerized tools for disigning and implementing one or more treatment plans for automated interactive management of one or more individuals having one or more diagnosed medical conditions or for health maintenance of one or more apparently healthy individuals.

The present invention claims priority from U.S. Provisional Application No. 60/333,837 filed Nov. 28, 2001 and hereby incorporates by reference any and all materials disclosed therein.

### 1. FIELD OF THE INVENTION

The present invention relates to methods and apparatus for automated interactive management of the health status of individuals who are under the care of one or more health professionals.

### 2. DESCRIPTION OF THE RELATED ART

As the average age of the population continues to increase, the number of people having chronic health issues continues to grow. In today's age of specialization, it is becoming ever more likely that people with chronic health problems will see one or more specialists for each of their health problems. In addition, with the advent of managed care, the number of treatments and procedures provided on an outpatient basis has also increased, often leaving a disjointed approach to treatment.

In addition, it is also known that conflicting treatments, including but not limited to administration of therapeutic drugs, can impede the management of one or more chronic health problems in a particular patient. In a worst cast scenario, conflicting treatments can prove fatal.

Most health care professionals will acknowledge that patients often fail to list all their medications, treatments, and health problems on the questionnaires normally given to patients. Sometimes the information is forgotten or overlooked by the patient, but it can also be selectively withheld because the patient doesn't think it is relevant to the particular condition for which he/she is currently seeking treatment. However, if a patient fails to reveal a heart condition, diabetes, or taking a blood thinner when visiting the oral surgeon, this could have catastrophic results.

Sometimes patients are embarrassed to disclose health problems, even to other health care professionals, and the possibility of harm from disjointed and conflicting courses of treatment is a very real problem.

In addition, currently patient data (medical records) are generally fragmented across multiple treatment sites, kept on centralized data banks (HMO, hospitals etc.) which do not communicate with each other. No single institution can hope to encompass a patient's entire record. This poses an obstacle to clinical care, research, and public health efforts. The lack of a common platform or connectivity between the patient, their own physician, hospitals, HMOs and other community resources results in inconsistent (and sometimes conflicting) application of evidence based treatments, inhibits standardized guideline based care, increases test duplication, and does not promote patient empowerment.

An additional problem encountered in the prior art relates to the actual determination of a treatment plan for a particular patient. Such a determination relies on medical guidelines established by various medical authorities. The practice of medicine according to guidelines, although medically and legally advantageous, is an elusive goal. Because of the complexity of scientific facts which need to be addressed, the volume of statements and recommendations published by professional review committees frequently reaches more than 70 pages per topic. For example, the 6^{th} report of the Joint National Committee on Prevention, Detection, Evaluation, and Treatment of High Blood Pressure comprises 73 pages. When dealing with a hypertensive patient with chronic atrial fibrillation and stable angina pectoris, a frequent combination in daily clinical practice, the treating physician would need to review 163 pages of guidelines. Moreover, physicians are required to keep track of regular guideline updates, and to be aware of additional evidence-based research, which may influence the standard of care even before being incorporated in new guidelines. The impracticability of a careful guideline review before design of a patient treatment plan is frustrating and is one of the causes for the gap between the publication of recommendations and their implementation.

The second obstacle to implementation of guidelines is their lack of specificity. This is particularly evident in the case of recommending a medication. Guidelines are rules which assume the form: “If A, then apply/consider medication class X” or “If A, then apply/consider medication class X, unless contraindicated”. They do not include a comprehensive list of such possible contraindications (of the class of medication or a specific drug belonging to that class), the medication's possible side effect, possible positive and negative interactions with other medication, titration protocols etc. Some of these data are found in pharmaceutical directories, which again have a sizable volume, and are therefore only consulted sporadically as reference books. Moreover, these directories are descriptive rather than prescriptive, and therefore lack the incorporation of guideline-based treatment rules.

A further aspect of the present invention seeks to overcome this problem in the prior art by establishing rules which combine guidelines with other medical information such as institutional practices, HMO requirements, and in the case of medications, table-structured pharmaceutical descriptions.

### SUMMARY OF THE INVENTION

Accordingly, the present invention provides methods and apparatus for automated interactive management of individuals (especially ambulatory individuals) who are under the care of one or more health professionals.

In a first embodiment, the invention provides an automated method for health management of a subject (e.g. an ambulatory subject) comprising:
(a) receiving health status input from the subject;
(b) processing the health status input in a computer in accordance with an approved treatment plan for the subject to generate health advice output for the subject; and
(c) transmitting the health advice output to the subject.

Preferably, the treatment plan is approved for the subject by a licensed health care provider.

In a second embodiment, the invention provides a computer-assisted method for generating a proposed treatment plan for health management of a subject (e.g. an ambulatory subject), comprising:
(a) receiving intake or follow-up health data concerning the subject; and
(b) processing the intake or follow-up health data in a computer in accordance with a set of treatment plan creation rules to generate a proposed treatment plan.
   Step (b) optionally comprises (i) detecting one or more conflicts arising from application of the treatment plan creation rules to the health data, and (ii) resolving the detected conflicts or presenting the detected conflicts for resolution by a skilled human user, e.g. a health care professional.
   In a preferred embodiment, the method further comprises:
(c) obtaining approval for the proposed treatment plan, with or without modification thereof, from a licensed health care provider, thereby generating an approved treatment plan for the subject.

Preferably, the set of treatment plan creation rules has been endorsed by an institution such as a clinic or a health maintenance organization having responsibility for medical management of the subject.

In a third embodiment the invention provides a computer-assisted method for obtaining a set of treatment plan creation rules, comprising:
(a) selecting at least one set of machine-based rules that embody guidelines for managing at least one medical condition and if a plurality of sets has been selected, combining them into a single selected set;
(b) resolving any conflicts detected within the selected set of machine-based rules to form a conflict-resolved rule set, wherein the detected conflicts have been identified by computer-mediated interaction or analysis of the selected set of machine-based rules;
(c) customizing the conflict-resolved rule set to form a set of treatment plan creation rules. Preferably, the step of customizing reflects institutional practice or recommendations of an institution authoring the set of treatment plan creation rules. In one embodiment, the invention further comprises:
(d) publishing the set of treatment plan creation rules by making it accessible to a subscribing health care provider or institution.

The invention further provides systems for performing any of the above-identified methods; a computer programmed to implement one or more of the above-identified methods; and a computer-readable medium comprising instructions for causing a computer to implement one or more of the above-identified methods.

### BRIEF DESCRIPTION OF THE FIGURES

FIG. 1 presents a flowchart illustrating a preferred embodiment of the invention.

FIG. 2 illustrates an embodiment of the logical architecture according to an embodiment of the present invention.

FIG. 3 illustrates functional system architecture according to an embodiment the present invention.

FIG. 4 illustrates an overview of an embodiment of the invention which generates medication and target value modules.

FIG. 5 illustrates an overview of an embodiment of the invention which generates patient-tailored treatment plans.

FIG. 6 depicts an exemplary schematic of a drug module.

FIGS. 7-10 provide a detailed flowchart analysis of the application of an embodiment of the invention to a virtual patient.

FIGS. 11-14 illustrate the application of an embodiment of the invention wherein drug modules information is used to generate a specific treatment plan.

FIG. 15 illustrates types of information contained in a treatment plan.

### DETAILED DESCRIPTION OF THE PREFERRED EMBODIMENTS

The present invention provides computerized tools for designing and implementing one or more treatment plans for automated interactive management of one or more individuals having one or more diagnosed medical conditions or for health maintenance of one or more apparently healthy individuals.

As used herein, the term “computerized tool” includes a computer-readable medium embodying a computer program, a computer on which a program is implemented, and a method that comprises operating a computer in accordance with a computer program. In different aspects, the invention provides (a) a computerized tool by which an authoring institution (e.g. a specialist clinic) can author and publish one or more sets of rules and protocols for preparing a treatment plan; (b) a computerized tool by which a subscribing institution (e.g. a physician or clinic responsible for patient management) can select one or more published sets of rules and protocols and apply clinical data concerning an individual in order to prepare and authorize a personalized treatment plan for management of that individual; and (c) a computerized tool for interactive health management of one or more individuals each in accordance with a personalized treatment plan.

In one embodiment, the computerized tools of the invention are accessible via a web-enabled user interface; alternatively, they are accessible via an intranet, a standard in-office computer, or via other devices such as a web phone, cellular phone, landline phone, or a portable electronic device (e.g. a laptop or sub-notebook computer, a palm pilot or similar instrument) using wired or wireless communication. The invention further provides computer tools for performing ancillary functions, including without limitation security, whereby access is limited to authorized users who in turn are limited to accessing only authorized components or information; and accounting, whereby usage by an authorized user is tracked, e.g. for billing purposes, which may if desired be implemented by an automated billing routine.

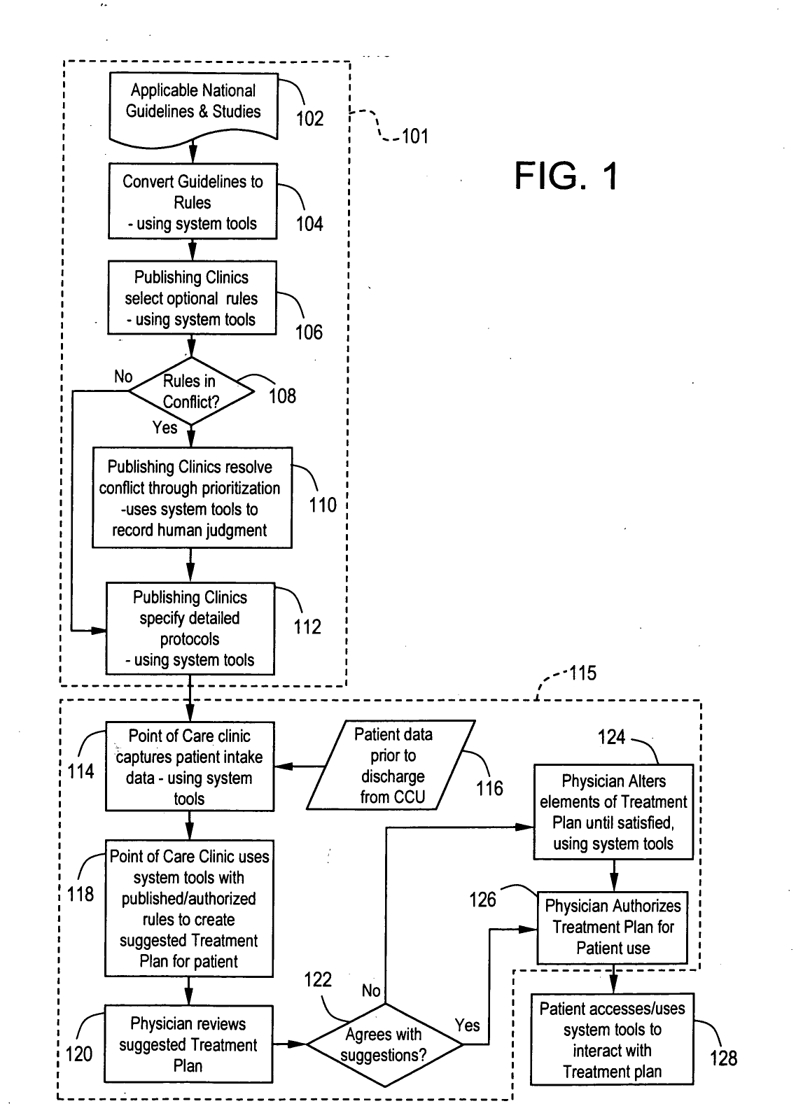

FIG. 1 illustrates a preferred embodiment of the invention which is described below with respect to general functional headings.

Generating Computerized Rule Sets

In a preferred embodiment, a hierarchical, multi-level computer-mediated procedure 101 is used to generate and publish a set of treatment plan rules. In this embodiment the invention provides computerized tools whereby an institution (known as an “authoring institution” can establish one or more detailed protocols that embody its institutional practice patterns for management of patients and can publish protocols for use by subscribing institution for use in patient management.

In particular and as depicted in FIG. 1, the invention accesses one or more databases 102 containing applicable national guidelines and/or studies. The invention provides one or more computerized tools (which may be referred to as a “Rule Generator” or “Guideline Blender”) for generating computer-mediated rules for health management. That is, as depicted as step 104 the Rule Generator provides a tool for transforming a set of health care Guidelines into a set of machine-based rules.

Examples of guidelines that may advantageously be represented in the form of machine-based rules include guidelines for treatment or management of lipid disorders, diabetes mellitus, hypertension, post-myocardial infarct status, and rehabilitation of one or more medical conditions. Preferably, the guidelines have been adopted, established or published by regional, national or international health organization, such as the American College of Cardiology (ACC), American Heart Association(AHA), Canadian Cardiovascular Society (CCS), Canadian Medical Association (CMA), or the European Society of Cardiology (ESC).

In a preferred embodiment, a plurality of guidelines for managing a plurality of conditions are integrated or blended into a single rule set (which may be referred to as a “Guideline Applicator”. If desired one or more such rule sets may be maintained in a database, for example in a database maintained by a service provider, for use by authoring institutions as described herein in conjunction with the computerized tools of the invention. The result of this process of integration is a single Guideline Applicator for managing a plurality of conditions or, more preferably, a plurality of Guideline Applicators, e.g. an ACC/AHA Guideline Applicator, an ESC Guideline Applicator, a Canadian Guideline Applicator, and a Most Recent Guideline Applicator (which may be derived by integrating the most recently published guidelines for a plurality of conditions).

As indicated in step 106 of FIG. 1, machine-based rules may also be derived from sources other than guidelines, including without limitation non-guideline evidence-based studies such as HOPE, ALLHAT, etc. and established practices of an authoring institution. By using a rule set derived by integrating a plurality of guidelines and/or other sources, the data for a patient can be applied to a single algorithm rather than to a plurality of individual flowcharts. This advantageously reduces the number of rule conflicts to be resolved, as described herein, and advantageously permits implementation of one or a few periodically updated algorithms rather than a myriad of individual flowcharts.

Preferably, the rule set is capable of distinguishing a plurality of different classes of treatment indications and goals. In one embodiment, Class I recommendations are those for which there is evidence and/or general agreement that a given procedure or treatment is beneficial, useful, and effective; Class II recommendations are those for which there is conflicting evidence and/or a divergence of opinion about the usefulness/efficacy of a procedure or treatment; and Class III recommendations are those for which there is evidence and/or general agreement that a procedure/treatment is not useful/effective and in some cases may be harmful. In a further embodiment Class II recommendations may be further divided into Class IIa recommendations wherein the weight of evidence/opinion is in favor of usefulness/efficacy and Class IIb recommendations wherein the usefulness/efficacy is less well established by evidence/opinion.

In additional embodiments, a single expert or an expert panel can be used for classifying indications or recommendations into a plurality of classes. In one embodiment of the invention this classification is performed based upon the medications to be prescribed. This use of drugs as the classification module will be described below in greater detailed and will be used as examples for clarification of the invention.

In a preferred embodiment, the system provides for automated conflict recognition 108. This may be implemented by providing “atomic rules” or “rule-lets” that have the ability to interact with other rule-lets to determine whether there are any conflicts within a given rule set. Programming techniques are known in the art for implementing automated conflict discovery. Two examples of such rule management software programs are Blazesoft (published by Blaze Advisor, San Jose, Calif.) and ILOG JRules (published by ILOG, Mountain View, Calif.).

In one embodiment, automated conflict discovery is provided by implementing the following features: (1) a mechanism for programmatic run time discovery of the presence and type of objects within the system; (2) a mechanism for programmatic run time interrogation of objects to determine their properties such as trigger conditions and outcomes/effects; and (3) a mechanism for cross-correlation of trigger conditions and outcomes to determine if there are conflict situations.

Techniques for implementing run-time discovery and typing are known in the art. For example, the Java and C++ programming languages directly support run-time typing. See Bjarne Stroustroup, The Design and Evolution of C++, Addison-Wesley, 1994; Mark Grand, Java Language Reference, O=Reilly & Associates, 1997. Moreover, both Java and the CORBA specification provide mechanisms and interfaces for determining object types at runtime. See Andreas Vogel and Keith Duddy, Java Programming with CORBA, John Wiley & Sons, 1997. The CORBA specification (and most commercial ORBs) provide an object registration mechanism and interfaces to support runtime property examination of objects. See id. Furthermore, several design patterns have been described in the literature that assist in creating and maintaining a software architecture where new entity types may be created and introduced into the system in such a manner that other entities may examine them and their properties at runtime. For example, the Reflection pattern provides a meta-model based architecture to allow for future system extension and data-driven behavior modification. See Frank Buschmann, “Reflection”. In Pattern Languages of Program Design 2, edited by Vlissides, Coplien and Kerth, Addison-Wesley, 1996. The Abstract Factory or Builder patterns may be used to create the different types of required rules at run time. The Visitor, Iterator and Mediator patterns may be used to create the mechanisms for evaluating all required conditions and outcomes. See Gamma, Helm, Johnson and Vlissides, Design Patterns, Addison-Wesley, 1994. Thus, one of ordinary skill in the art can readily implement a system architecture, using known programming techiques, to support the dynamic rules engine described herein.

Generating Treatment Plan Creation Rules

The invention provides a computerized tool (the “Rules Manager”) by which an authoring institution (for example a specialist clinic or a leading institution such as the Mayo Clinic) can adopt a customized set of rules and protocols that embody that institution's practices and recommendations for creating treatment plans for health management. Preferably, the Rules Manager is implemented in a user-friendly screen-based interactive format.

If desired, and as indicated in step 112 of FIG. 1, the authoring institution can publish one or more customized treatment plan creation rules for use by authorized institutions providing health management. If desired, customized treatment plan creation rules can be branded to reflect the approval of the authoring institution, thereby facilitating the widespread use of customized rule sets published by prestigious institutions. Thus, the present invention enables leading clinics to specify in electronic format their rules for creating guideline-compliant treatment plans for management of patients with one or more chronic illnesses. The invention further enables such clinics to brand and redistribute these treatment plan creation rules to specific partner clinics.

In a further embodiment of the invention, security features permit access to published rule sets to be restricted to authorized users and accounting features provide automated billing when published treatment plan creation rules are accessed or used.

Prior to this publication, the invention permits the authoring institution to utilize various aspects of the Rules Manager to derive these customized rules. A first aspect of the Rules Manager is an editing function by which the authoring institution selects and blends sets of rules. Selection may comprise selecting one or more rules sets derived from national guidelines and non-guideline sources. For example, an institution may select rule sets to be combined that embody the ACC/AHA guidelines for managing hypertension and post-myocardial infarct status and the CCS/CMA guidelines for managing diabetes mellitus. In addition, the authoring institution can select which optional recommendations (e.g. Class II recommendations) to include and which evidence-based studies to incorporate and may if desired modify these rules in accordance with its own institutional practice.

Upon selection of the rule sets, treatment recommendations of individual guidelines (e.g. rules of treatment, indications, contra-indications) are combined by the software and conflicts between different rules are identified by the software (step 108) for resolution. In one embodiment, conflicts are presented (e.g. on screen or in a computer printout) for resolution by a skilled user (e.g. a clinician, dietician, exercise therapist) or panel of experts, such as one or more medical practitioners. A preferred method of resolving conflicts is by prioritization. The result is a blended list of conflict-resolved rules. At this stage, the recommendations are in generic form, e.g. specifying categories of drugs (such as ACE inhibitors, anticoagulants, beta-blockers, cholesterol-lowering agents, loop diuretic, thiazide diuretics) exercise goals, and dietary goals.

In a second aspect, the Rules Manager prompts the authoring institution to select specific means of implementing each general recommendation. This customization process may include, without limitation, any or all of the following: (a) for a category of class of medications, which medications of that class (proprietary or generic) are used in the institution's practice patterns and in what priority; (b) for each selected medication, what titration schedules are followed and what sort of side-effects screening is performed; (c) institutional choices for ongoing laboratory tests, or vital sign acquisition and feedback; (d) types of exercise prescribed or recommended by the institution and the nature of a progressive exercise plan presented to patients by the institution.

In a preferred embodiment, the invention provides a Protocol Authoring Tool by which the authoring institution can access default titration schedules for each selected medication (which can be based on recommendations issued by the manufacturer or published in the medical or pharmaceutical literature) and can optionally modify these default protocols to reflect the institution's own practice patterns. Preferably, the Protocol Authoring Tool also provides information concerning dosages and drug interactions and contraindications.

The result of this process is a customized set of treatment plan creation rules with associated protocols that may if desired be branded and published for use by partner clinics.

Creating an Individualized Treatment Plan

As depicted in FIG. 1, the invention provides a computerized tool, the “Treatment Plan Generator” (115), by which a user (e.g. a health care practitioner or a treatment clinic) can generate, if necessary revise, and then authorize a customized plan for health management of an individual.

In a first aspect, clinical data specific to the individual is attained (116) and recorded (114) in the computerized system. Such data may include, without limitation, any information with regard to patient height, weight, blood type, chronic illnesses, medications, genetic abnormalities or susceptibilities, family history, medications, previous illnesses, etc. In one embodiment, patient-specific clinical data are entered in machine-readable format, e.g. by a health care professional or support staff assisting such a professional; this may be implemented by an interactive computerized intake form or dialog or by means of a portable (e.g. palm held) device. Alternatively, patient clinical data can be captured by coding on written sheets for automated capture or manual entry by clerical staff.

In a preferred embodiment, computerized software is implemented in the clinic that captures relevant patient data during in-patient management and passes it to the Treatment Plan Generator, thereby providing a seamless transition from in-patient to ambulatory management. Information captured during the intake process may include, without limitation, any or all of the following: demographic information, presenting medical history, results of laboratory tests performed prior to discharge (or on prior visits in the case of an individual who has not been admitted as an in-patient), current medications that the patient is taking, and lifestyle information such as data relating to diet, exercise patterns, smoking, etc.

After entry of initial patient data, the health care professional (e.g. medical practitioner) selects a set of treatment plan creation rules from the list of rules to which access has been authorized for that professional, treating clinic or the patient concerned. In one embodiment, the set of treatment plan creation rules has been authorized by a health care insurance carrier for use with the patient. The Treatment Plan Generator applies the selected rules and associated protocols to the patient data to generate (step 118) a proposed individualized treatment plan.

The software of the invention permits the health care professional to revise and fine tune the proposed treatment plan and to save successive versions before or after modification (steps 120-126). Once the health care professional has authorized the plan, with or without modification, the authorized plan is made available to the patient within the Self-Care Tools environment of the present invention (step 128).

Thus, the Treatment Plan Generator provides an individualized Treatment Plan, authorized by a health care professional (preferably a licensed health care professional such as a physician) that provides specific directions for the patient to follow. In one embodiment, the Treatment Plan specifies at least one medication and for one or more specified medications provides a defined titration algorithm and defined feedback measures. For example, a treatment plan may specify therapy with an identified ACE inhibitor (say, Altace), starting at 2.5 mg/day in the evening for one week, increase to 5 mg/day, after 2 weeks check BP, if systolic >100 mmHg, increase to 10 mg/day. Similarly, a treatment plan may specify detailed diet and exercise protocols as well as other health care interventions, such as for stress reduction and cessation of smoking.

In a preferred embodiment, the treatment plan includes details of one of more of the following: planned follow up visits, timing and nature of ambulatory monitoring (e.g. acquisition of vital signs or other health status information such as body mass and exercise tolerance), and criteria for additional monitoring or intervention (e.g. threshold heart rate or blood pressure requiring expedited follow up or intervention).

Remote Support and Monitoring of Patients

Additional embodiments of the invention provide computerized Self-Care Tools that permit remote support and monitoring of ambulant patients. These tools advantageously permit delivery of just-in-time training and information to patients and to caregivers, and further permit patients to transmit information for use in automated monitoring of health status.

In such embodiments the invention provides a platform for creating or assembling each patient's personal health record from fragmented sources so that it is accessible at all points of care within the health service and contains data from all institutions and health care service provides involved in that patient's care. Further, the present invention permits a patient centric health management platform, which links the existing data banks at the different points of care by transporting validated essential health data from one central data repository (e.g. hospital) to another (e.g. HMO). This advantageously provides data congruence, avoids data loss, promotes safe implementation of therapy, and reduces medical errors.

A wide variety of devices may be used to receive input from and transmit output to patients; such devices include a web-based access device (e.g. a computer equipped with a web browser), a portable or palm device, a mobile or landline telephone, a fax machine or a pager. For support and monitoring of elderly patients, simple and familiar communication devices are preferred. Especially preferred for more sophisticated users is a portable device comprising memory (e.g. flash memory), an input device (e.g. one or more keys, a touch screen), an output device (e.g. a display such as a screen, a speaker, a buzzer, a vibrator) and a communications interface (e.g. an interface capable of communicating directly or indirectly with a computer) and programmed to receive, store and implement a machine-readable treatment plan for one or more specified subjects. Preferably, the device provides support to facilitate performance by the user of time-dependent tasks (e.g. taking medication or exercise according to a prescribed scheduled). The device optionally provides direct or wireless 2-way communication; e.g. by means of protocols such as Bluetooth, IRDA, GSM and the like. Optionally, the device can plug directly into a computer port such as a USB port for synchronization or information transfer. Preferably the device provides security features for protecting the treatment plan information.

In one embodiment, information provided to patients may comprise any or all of the following, without limitation: (a) information concerning prescribed medications, for example the timing and dosage of medications, titration schedule, side effects and contra-indications; (b) information concerning scheduled health care appointments; (c) information concerning prescribed dietary measures or dietary recommendations; (d) information concerning a prescribe exercise regime or exercise recommendations; (e) urgent notification, e.g. upon a vital sign or other monitoring criterion exceeding a threshold value; (e) health information appropriate to the patient's health status, for example text or links to relevant websites; (f) social support, such as email or instant message communication links with friends or health care support workers; and (g) a notification icon indicating the arrival of urgent information concerning the patient's health status or management (e.g. the need to contact a health care provider).

In one embodiment, the system or software of the present invention is capable of interfacing with remote peripheral devices to provide health support. In one example, the present invention provides a robotic device (which may optionally be under remote computer-mediated control) for dispensing medication in accordance with a prescribed regimen or titration schedule. This may advantageously be used in order to improve compliance and avoid confusion, especially in elderly patients or patients on multi-drug therapy or complicated dosage regimes. The robotic device optionally signals the need to take medication, for instance by a visual, audible or vibrating signal or by providing text on an output device such as a screen. The robotic device may dispense the appropriate dose of one or more medications, e.g. from one or more reservoirs filled at a pharmacy or drugstore or by a visiting health care worker. The device may also record the fact and timing of dosing or removal of dispensed medication for future evaluation by health care providers. In one embodiment, the device alerts a central monitoring system or a health care provider when compliance with a prescribed regimen fails to satisfy specified criteria. Preferably, the device is portable and may optionally be adapted to be carried in a purse or pocket.

In further embodiments of the invention, the monitoring function of the invention permits the monitoring of a collection of individual patients and thereby provides additional benefits to the medical community as a whole. In one such embodiment, the system enables longitudinal tracking of validated data, statistical analyses of various kinds and outcome research at any point in time. This permits academic, health care institutions, and even individual primary care physicians to determine the medical and economic effects of their specific treatment plans in their specific patient population rather than relying on data from the literature which have been gathered on other patient populations. This portable, web-enabled observational data bank will help refine their treatment and subsequently verify the effect of such refinements. It will therefore be helpful both for improvement of treatment as well as reducing health care costs (increasing cost-effectiveness). In additional embodiments it permits automated comparison of two or more patients, or groups of patients, that are being treated by alternative treatment regimes (e.g., in drug trials) thereby permitting comparison of their efficacy and/or adverse effects.

Overall System Architecture

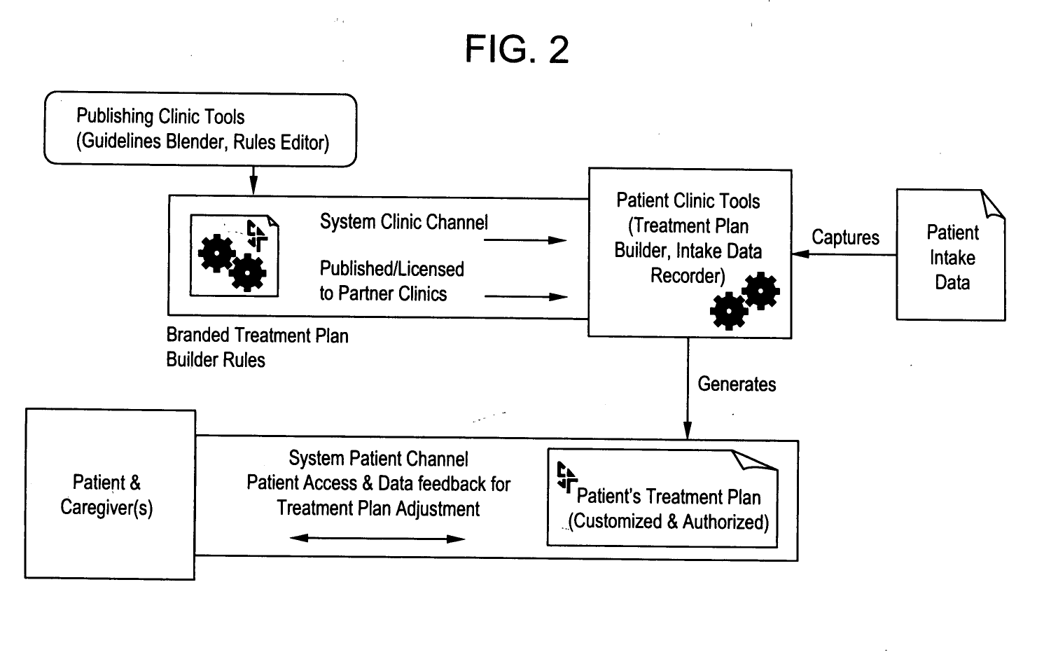

FIG. 2 provides a general overview illustrating the system architecture of the various embodiments of the invention described above. As illustrated, the invention provides tools for three different audiences; protocol publishing institutions, patient clinics and physicians who need to author treatment plans and wish to monitor patient compliance and/or progress. The final toolset is aimed at the patients and caregivers themselves.

FIG. 2 also illustrates the logical relationship between the three different toolsets and illustrates the “connective tissue” of the overall system; the system channels. In additional embodiments of the invention, the Internet may be used as a connectivity and distribution platform. While the system may be envisioned as a secure client-server application, Internet protocols and existing infrastructure may be used to connect the different elements of the system and the user communities.

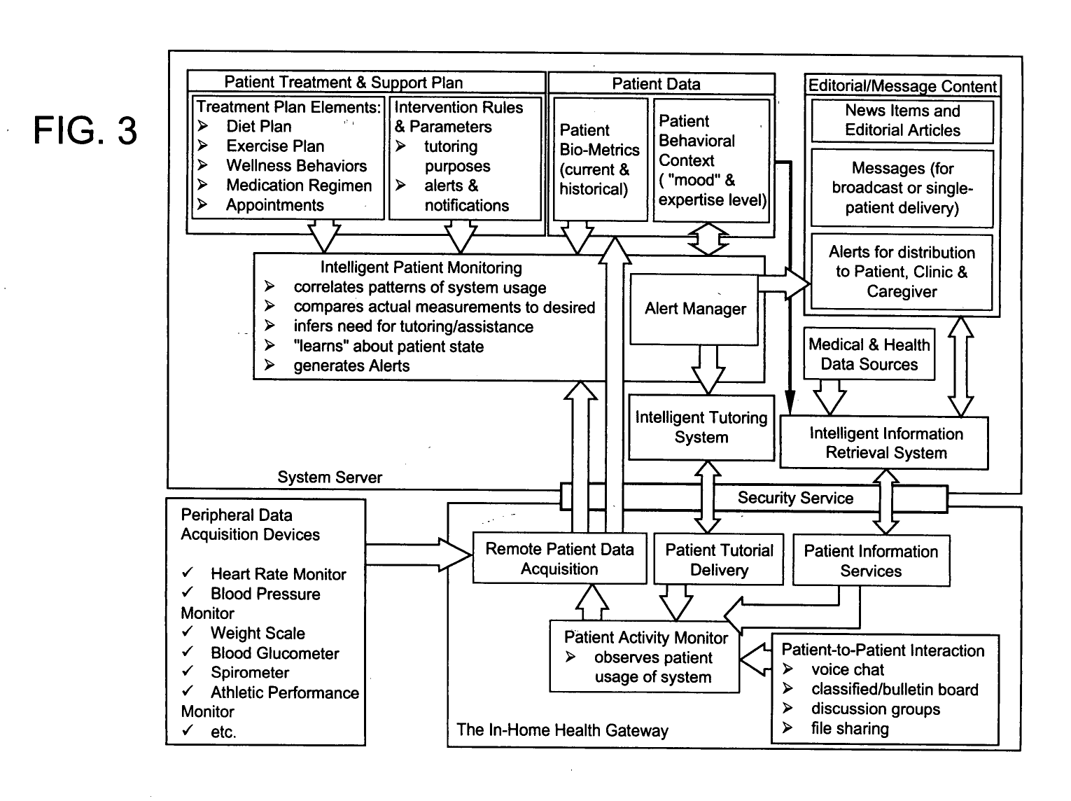

FIG. 3 further illustrates the various communication links of the present invention and the corresponding data which is communicated. It can be readily appreciated that the type of information being transmitted requires adequate security. In a preferred embodiment, the present invention meets or exceeds the security standards established by Health Care Financing Administration (HCFA/CMS) for Privacy-Act protected and/or other sensitive HCFA information sent over the Internet. This preferably includes standards that have been publicly proposed for Health Insurance Reform. Thus, information sent over the Internet can be restricted for access only by authorized parties. This is attained using web-based Data Management tools through both physical and logical methods. Preferably, the entire system and database is maintained in a secure, access controlled and monitored facility. From a logical security perspective, two primary areas are utilized: user authentication and data encryption.

In one embodiment of the invention at least two levels of encryption are employed. Secure Sockets Layer (SSL) is routinely used for doing interactive remote logins. In addition to encrypting information during data transfer through the HHTPS protocol, all sensitive individual patient data is encrypted within the database. Internet security is further enhanced by disabling unencrypted outside access to the network and minimizing the number of open ports and daemons running.

As is well known in the prior art, authentication may take several forms. At its most basic is simple password-protected logon paradigm. In addition to this first-pass authentication process, an additional embodiment of the invention uses digital certificates (e.g. stored on patient's PC or on the Web Phone Access Card) to verify the identity of authorized users.

Example of Implementation of System

In this example of an embodiment of the invention, the system uses a semi-automated process to generate a specific treatment plan tailored to the individual needs and objective data of patients. The process is based on self-assembly of drug-modules acting within the constraints of patient-specific target values and limits derived from the patient's data set, and implemented using an interactive multi-drug titration protocol, which allows to quantitatively predict desired and undesired effects of the treatment plan according to established pharmacodynamic models.

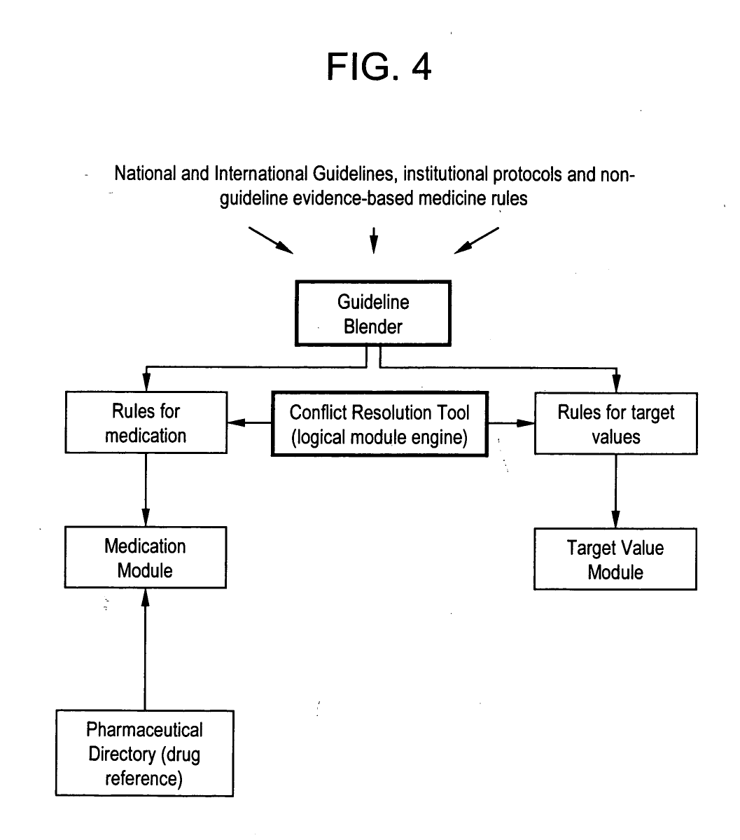

In order to do so, an authoring tool is utilized which generates medication and target value modules; these module interface with a default titration protocol to produce a patient-tailored treatment plan. FIG. 4 provides an overview of the authoring tool for generating medication and target value modules. The operational knowledge content of the relevant guidelines, institutional protocols and evidence-based medicine studies is disintegrated by the guideline-blender and separated into rules for the use of medication (e.g. compelling indication—class-I-rules) and rules for target values (e.g. in heart failure reach blood pressure below 130/85 mm Hg). The medication rules are tested for logical conflicts using the logical module engine. Conflict resolution is achieved by prioritization: conflicts are detected and presented for resolution by a skilled human user (e.g. a health care professional or expert). The rules are embedded into the individual drug modules together with the relevant data derived from the pharmaceutical directory (e.g. data on synergistic or antagonistic effects with other drugs). All drug modules together form the medication module. The rules for target values are also tested for logical conflicts using a logical module engine and conflict resolution is achieved by prioritization as described above (e.g. target blood pressure in heart failure is >130/85 mm Hg; but if significant carotid artery stenosis is present is set at >130/85 mm Hg).

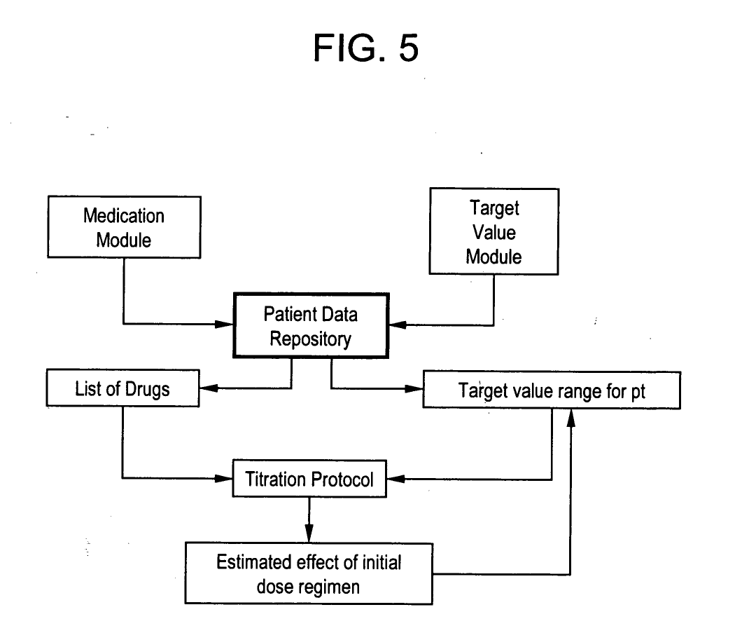

FIG. 5 illustrates an overview of the process of generating patient-tailored treatment plans. The medication and target value modules (derived in FIG. 4) are based on guidelines. The titration protocol is based on tested vendor recommendations, study protocols and legal requirements. Self-assembly of the drug modules interacting with the patient data generates a list of drugs. The range of target values is set by guideline goals and comorbid factors. Conflicts are detected and presented for prioritization (e.g. target blood pressure in heart failure is <130/85 mm Hg, but if significant carotid artery stenosis is present will be set at >130/85 mm Hg) as explained in FIG. 4. The effect of the initial dose regimen from the titration protocol on the target values is calculated based on published pharmacodynamic models (1^{st} iteration) and used to check—and if necessary modify—the titration protocol in advance (subsequent iterations).

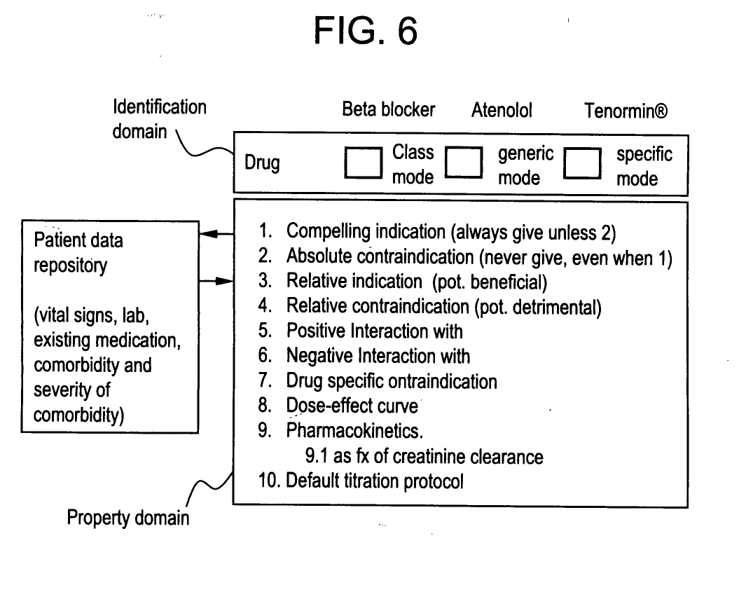

The above example relies on the use of drug modules. FIG. 6 illustrates an exemplary schematic of such a drug module. While guidelines result in complicated decision-trees requiring constant cross-checks with patient data as well as other guidelines, application of relevant drug modules with embedded rules and attributes (in the property domain) results in self-ensemble of drug recommendations with default titration protocols and estimation of effects on target values calculated from published data.

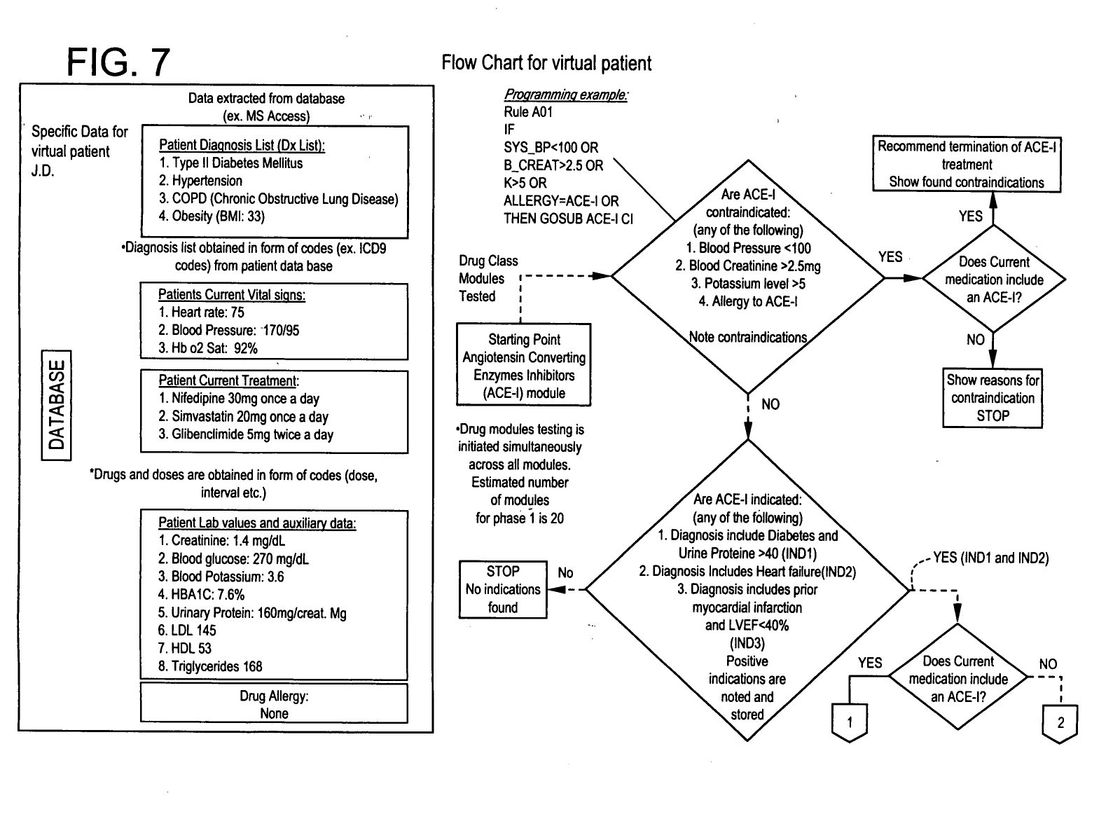

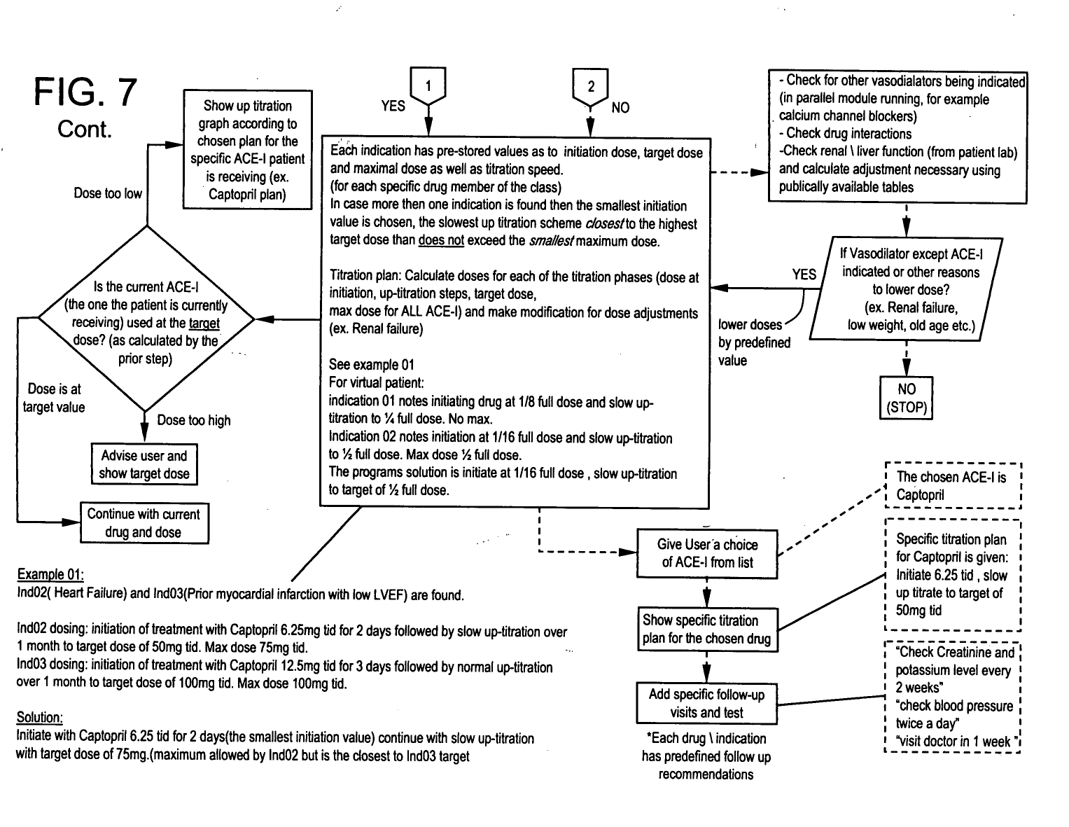

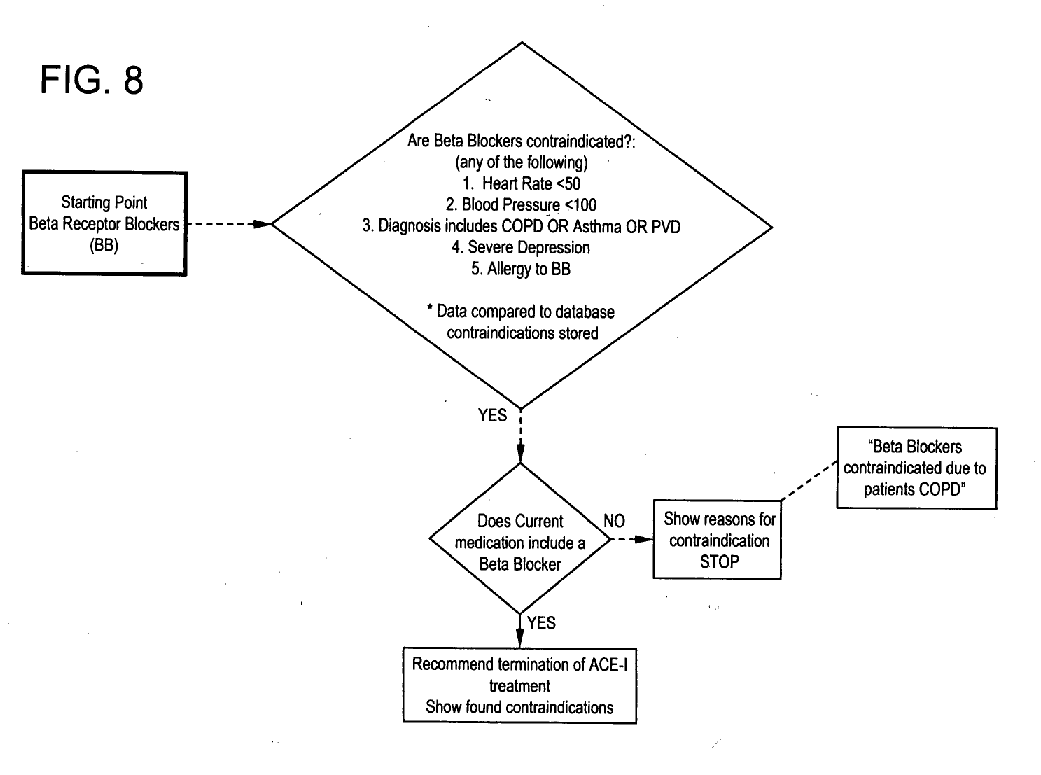

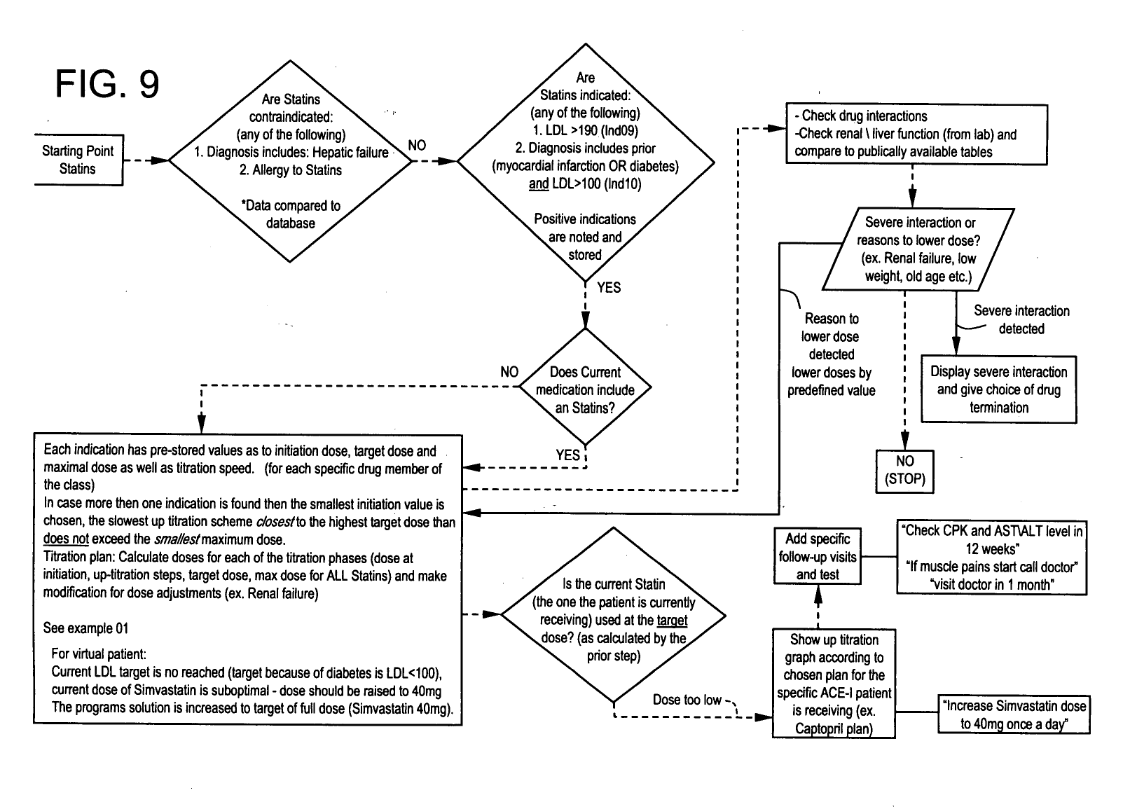

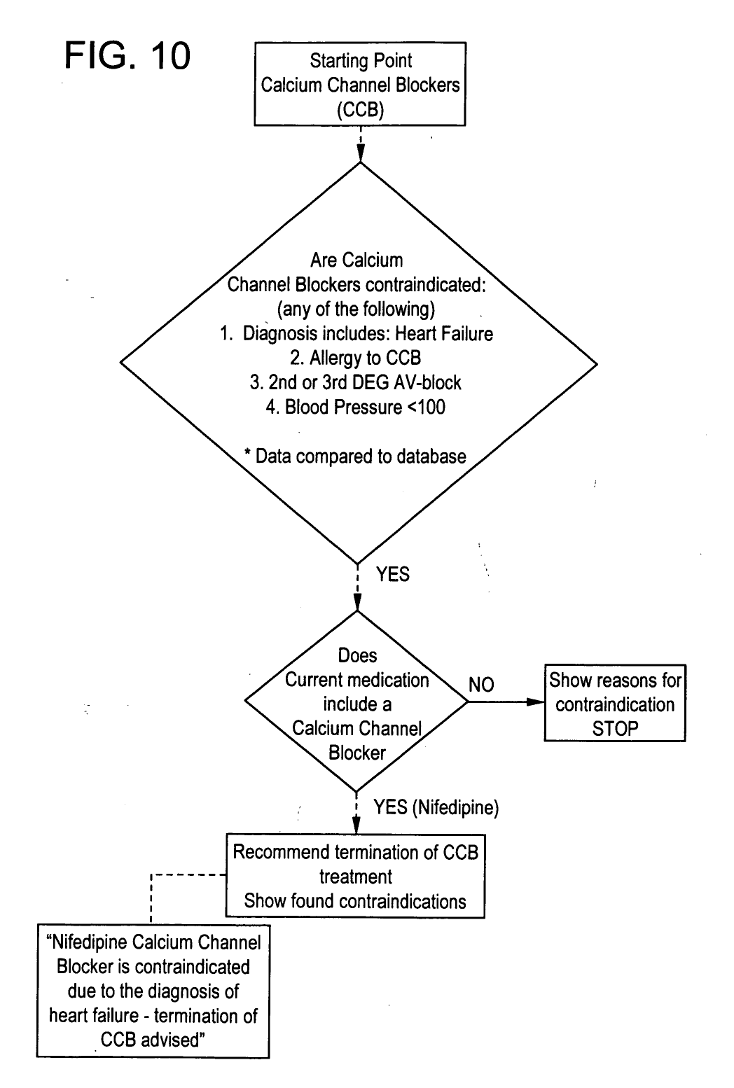

FIGS. 7-10 provide a more detailed flowchart analysis of the invention's use of drug modules. This analysis is exemplified for a virtual patient having specific data as noted in the Database at the left of FIG. 7. FIG. 7 further illustrates a starting point where ACE-1 drug modules are evaluated with respect to this patient data. FIG. 8 performs a similar analysis with respect to Beta Receptor Blocker drugs. FIGS. 9 and 10 contain further analysis with respect to Statins and Calcium Canal Blockers, respectively.

It should be noted that this analysis is not limited to only these four categories. All relevant drugs modules are tested, and the analysis of all such modules are run in parallel.

As indicated in the “Programming example” referenced at the top of FIG. 7, the rules utilized contain priority numbers thereby permitting execution in step wise fashion because data from parallel drug modules are needed for calculations.

Although not shown, drug interaction modules are commercially available and are used in executing the exemplified method.

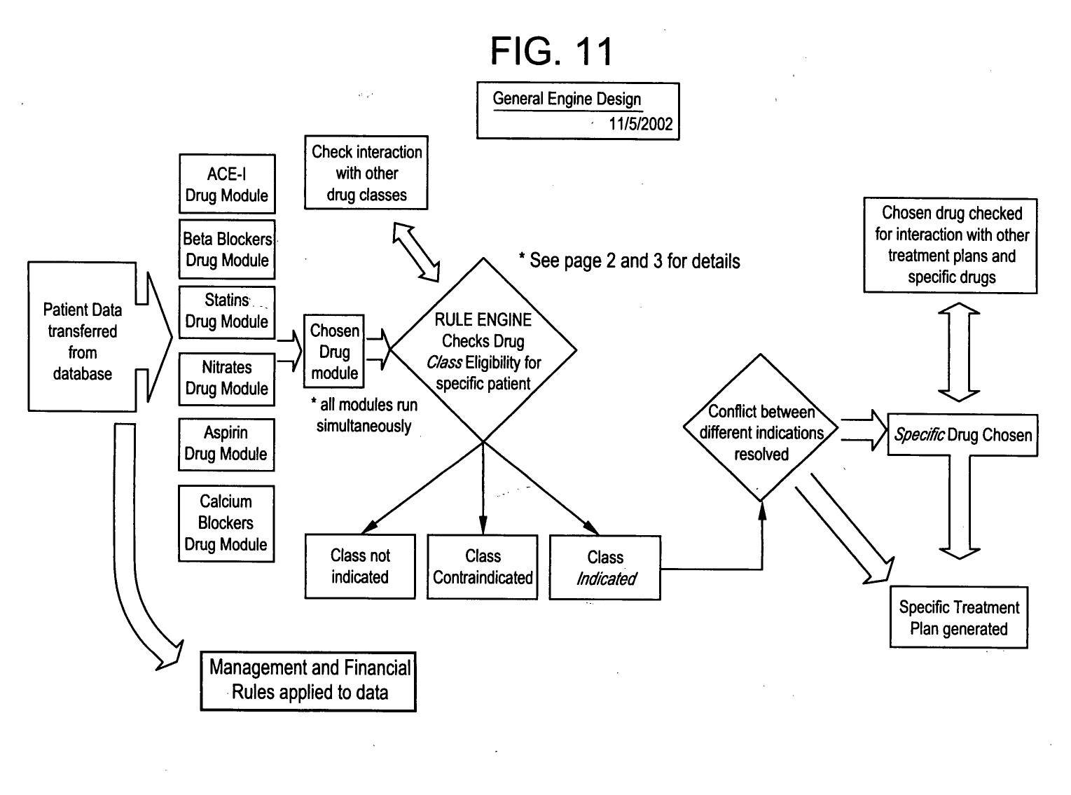

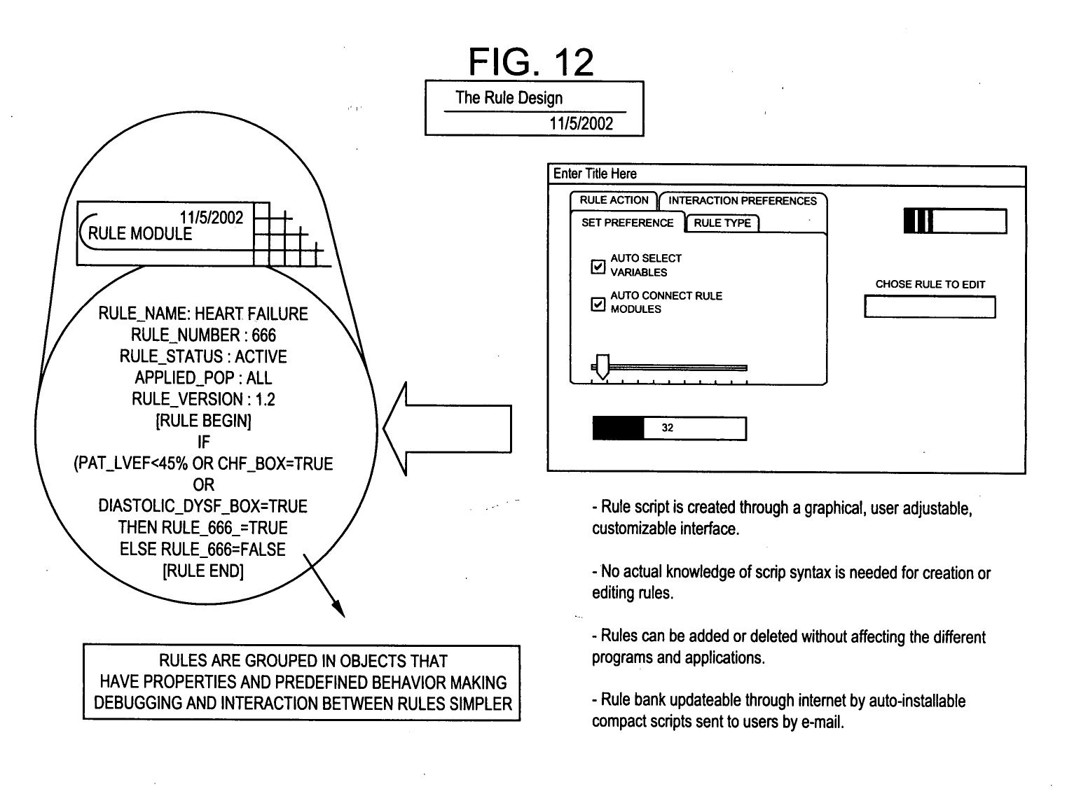

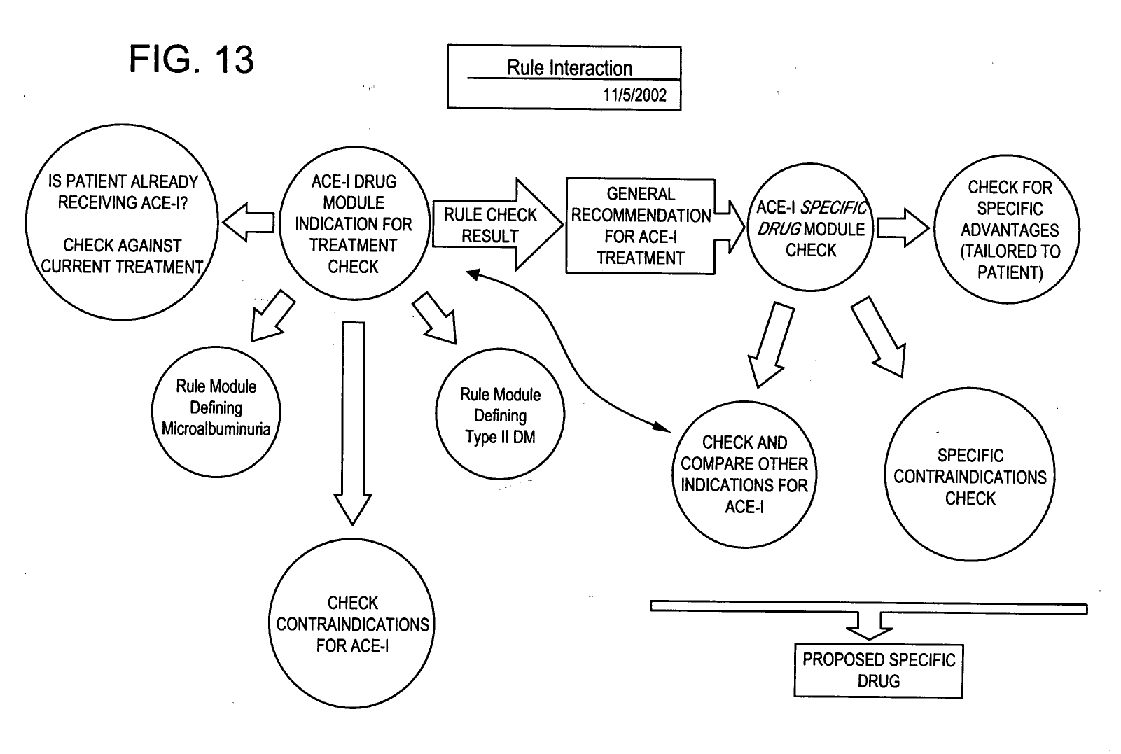

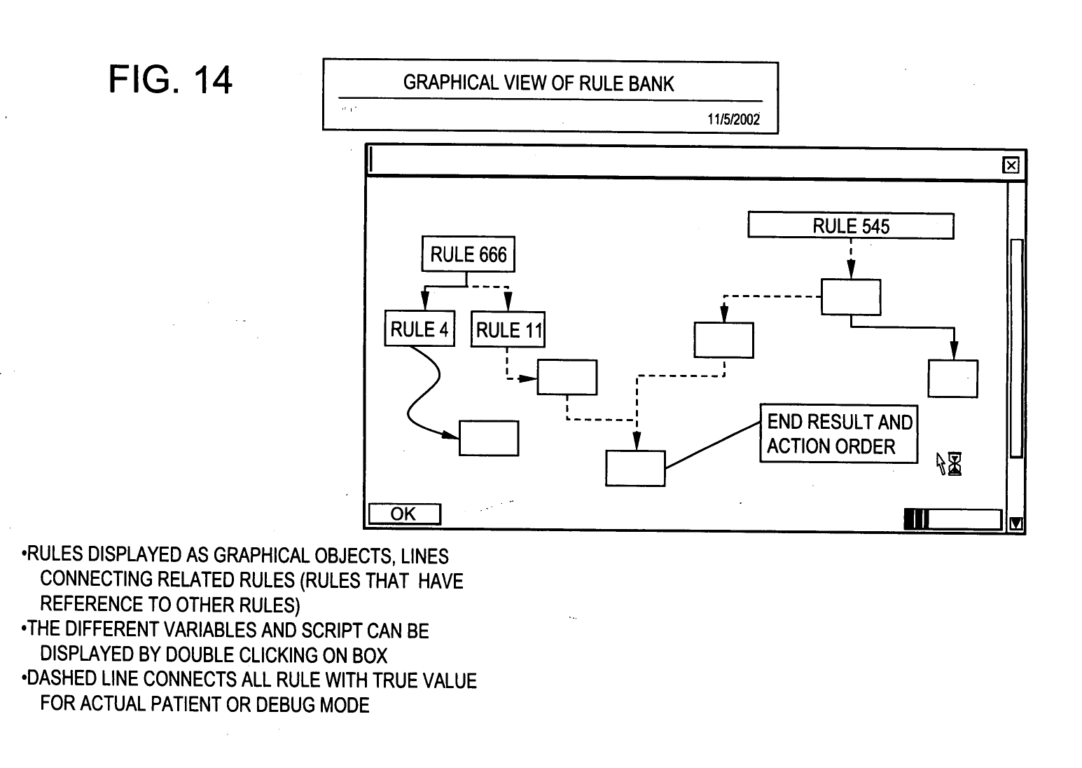

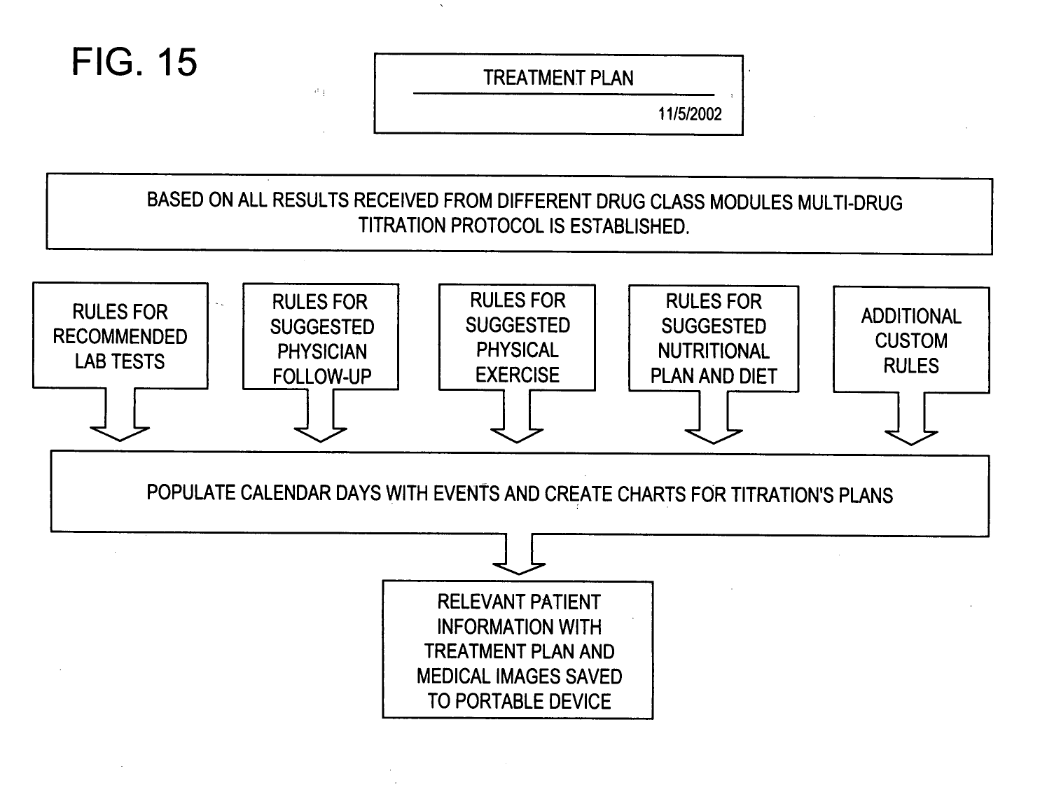

FIGS. 11-14 provide a further example of the refinement of drug modules into an ultimate decision of the drug to be utilized in a specific treatment plan. FIG. 15 illustrates that such a treatment plan includes, in addition to the drug titration protocol, rules for lab testing, physician follow-up, patient exercise, patient nutrition and additional custom rules.

The present invention is not to be limited in terms of the particular embodiments described in this application, which are intended as illustrations of individual aspects of this invention. Functionally equivalent methods and apparatus within the scope of the invention, in addition to those enumerated herein, will be apparent to those skilled in the art from the foregoing description and accompanying drawings. Such modifications and extensions are intended to fall within the scope of the appended claims.

Each reference cited above is hereby incorporated by reference herein in its entirety.

1. An automated method for health management of an ambulant subject comprising:
(a) receiving current health status input from the subject;
(b) processing the current health status input in a computer in accordance with an approved treatment plan for the subject to generate current health advice output for the subject; and
(c) transmitting the current health advice output to the subject.

2. The method according to claim 1, wherein the subject transmits the current health status input in machine readable format.

3. The method according to claim 2, wherein the current health status input is transmitting from an input device adapted to be carried or worn by the subject.

4. The method according to claim 1, wherein the current health status input comprises physiological data obtained from a monitoring device.

5. The method according to claim 1, wherein the current health advice output is transmitted to a receiving device that manifests the output to the subject.

6. The method according to claim 5, wherein the output is provided to the subject on a screen, in printed form, or in audible form.

7. The method according to claim 1, wherein the computer is programmed with a plurality of prospective treatment plans.

8. The method according to claim 7, wherein at least one of the plurality of prospective treatment plans is selected as said approved treatment plan for managing the health of the subject.

9. The method according to claim 7, wherein current health status input is received from each of a plurality of subjects and health advice output is transmitted to each of a plurality of subjects.

10. The method according to claim 1, wherein the computer is programmed with historical health information.

11. The method according to claim 10, wherein the historical health information comprises data concerning the subject received from at least one health care provider.

12. The method according to claim 10, wherein the historical health information comprises health information received from the subject on one or more prior occasions.

13. The method according to claim 12, wherein the historical health information comprises data concerning the subject received from at least one health care provider and health information received from the subject on one or more prior occasions.

14. The method according to claim 10, wherein the current health advice output is selected according to both the current health information and historical health information.

15. The method according to claim 1, wherein health advice output selected for the subject on one or more prior occasions has been stored as historical health advice output.

16. The method according to claim 15, wherein the current health advice output is selected according to both the current health information and the historical health advice output.

17. The method according to claim 10, wherein health advice output selected for the subject on one or more prior occasions has been stored as historical.

18. The method according to claim 17, wherein the current health advice output is selected according to the current health status input, the historical health status input, and the historical health advice output.

19. The method according to claim 10, wherein data concerning historical health status input are transmitted or displayed to a health care provider.

20. The method according to claim 18, wherein data concerning the historical health advice output are transmitted or displayed to a health care provider.

21. The method according to claim 20, wherein data concerning historical health information and data concerning historical health intervention(s) are transmitted or displayed to a health care provider.

22. The method according to claim 1, wherein the current health status input comprises data concerning the mass, nutrition, exercise, cardiovascular status, respiratory status, endocrine status, neurological status or affect of the subject.

23. The method according to claim 1, wherein the current health advice output comprises instructions for maintaining or modifying a regime of medication, exercise, nutrition and/or physical therapy, one or more motivational messages and/or instructions to visit a health care provider.

24. The method according to claim 23, wherein the current health advice output comprises machine-readable instructions for causing a device to dispense medication in accordance with a therapeutic regime.

25. The method according to claim 1, further comprising: providing informational material to the subject concerning a disease or health condition affecting the subject or which the subject is at risk of developing.

26. The method according to claim 25, wherein the informational material comprises educational text, a hyperlink, or information concerning a support group concerning the disease or health condition.

27. The method according to claim 1, further comprising: collecting data concerning the outcome of a therapeutic regime.

28. The method according to claim 27, wherein the therapeutic regime is a medication regime.

29. The method according to claim 27, wherein the outcomes of a plurality of therapeutic regimes are compared.

30. The method according to claim 27, wherein the data comprise data concerning a desired effect or an adverse effect.

31. The method according to claim 1, wherein the treatment plan directs management of one or more of the following modalities: diet, medication regime, exercise and wellness behavior of the subject.

32. The method according to claim 31, wherein the management of a first modality is adjusted to compensate for concurrent changes in a second modality.

33. The method according to claim 32, wherein the first modality is exercise to achieve a target heart rate and the second modality is a regime of a medicament affecting the cardiovascular system.

34. The method according to claim 33, wherein the medicament is a medicament affecting the heart rate.

35. The method according to claim 34, wherein the medicament is a beta blocker.

36. The method according to claim 32, wherein the first modality is diet and the second modality is a regime of a medicament affecting blood glucose.

37. The method according to claim 36, wherein the medicament is insulin or an oral hypoglycemic agent.

38. The method according to claim 31, wherein the medication regime comprises treatment with a plurality of medicaments.

39. The method according to claim 38, comprising adjusting dosage of a first medicament to compensate for a concurrent change in dosage of a second medicament.

40. The method according to claim 38, wherein the change in dosage comprises introduction or cessation of the second medicament or increasing or decreasing the dosage of the second medicament.

41. The method according to claim 39, wherein adjusting dosage of the first medicament comprises introducing or ceasing the first medicament or increasing or decreasing the dosage of the first medicament.

42. The method according to claim 31, wherein the wellness behavior comprises cessation or limitation of smoking or stress management.

43. The method according to claim 1, further comprising: transmitting machine-readable instructions for causing a robotic device to dispense medication in accordance with the approved treatment plan.

44. A computer-assisted method for generating a proposed treatment plan for health management of a subject, comprising:
(a) receiving intake health data concerning the subject; and
(b) processing the intake health data in a computer in accordance with a set of treatment plan creation rules to generate a proposed treatment plan.

45. The method according to claim 44, further comprising:
(c) obtaining approval for the proposed treatment plan with or without modification from a licensed health care provider, thereby generating an approved treatment plan for the subject.

46. A computer-assisted method for obtaining a set of treatment plan creation rules, comprising the steps of:
(a) selecting at least one set of machine-based rules that embody guidelines for managing at least one medical condition and if a plurality of sets has been selected, combining them into a single selected set;
(b) resolving any conflicts detected within the selected set of machine-based rules to form a conflict-resolved rule set, wherein the detected conflicts have been identified by computer-mediated interaction or analysis of the selected set of machine-based rules;
(c) customizing the conflict-resolved rule set to form a set of treatment plan creation rules.

47. The method according to claim 46, wherein the customizing step includes at least one of institutional practices and recommendations of an institution authoring the set of treatment plan creation rules.

48. The method according to claim 46 further comprising:
(d) publishing the set of treatment plan creation rules by making it accessible to a subscribing health care provider or institution.

49. The method according to claim 47 further comprising:
(d) publishing the set of treatment plan creation rules by making it accessible to a subscribing health care provider or institution.

50. A computer program comprising instructions for causing a computer to implement the method according to any one of claims 1 or 44-49.

51. A computer-readable medium having stored thereon instructions for causing a computer to implement the method according to any one of claims 1 or 44-49.

52. A computer programmed with instructions for causing said computer to implement the method according to any one of claims 1 or 44-49.

53. A robotic device for dispensing one or more medications in accordance with a therapeutic regime, said device comprising:
(a) one or more supply reservoirs containing a supply of medication to be dispensed;
(b) a chamber into which medication is dispensed;
(c) an interface for communicating data with one or more remote locations wherein said data comprises dispensing instructions executable by the robotic device;
(d) memory for storing said medication into said chamber in accordance with said dispensing instructions.

54. The robotic device of claim 53 wherein said data further comprises information from said robotic device concerning removal by a user of said dispensed medication from said chamber.

55. The robotic device of claim 53 wherein the device is portable.

56. A computer-assisted method for generating a treatment plan for health management of one or more individuals comprising the steps of:
A. authoring and publishing one or more sets of rules and protocols for preparing said treatment plan, by steps including:
(i) selecting at least one set of machine-based rules that embody guidelines for managing at least one medical condition and, if a plurality of sets have been selected, combining them into a single selected set; and
(ii) resolving any conflicts detected within the selected set of machine-based rules to form a conflict-resolved rule set, wherein the detected conflicts have been identified by computer-mediated interaction or analysis of the selected set of machine-based rules;
B. providing computerized instructions that enable a subscribing institution to select at least one of said one or more sets of rules and protocols and to apply clinical data concerning at least one of said one or more individuals in order to prepare and authorize a personalized treatment plan for health management of at least one of said one or more individuals; and
C. providing computerized instructions for interactive health management of at least one of said one or more individuals in accordance with a personalized treatment plan.

57. A computer-assisted method for generating a treatment plan for health management of one or more individuals comprising the steps of:
A. providing computerized instructions that enable an authoring institution to author and publish one or more sets of rules and protocols for preparing said treatment plan for health management of one or more individuals;
B. preparing and authoring a personalized treatment plan for at least one of said one or more individuals, by steps including:
(i) receiving intake health data concerning the said at least one of said one or more individuals, and
(ii) processing said intake health data in a computer in accordance with said rules, to create said treatment plan; and
C. providing computerized instructions for interactive health management of at least one of said one or more individuals in accordance with a personalized treatment plan.

58. A computer-assisted method for generating a treatment plan for health management of one or more individuals comprising the steps of:
A. authoring and publishing one or more sets of rules and protocols for preparing said treatment plan, by steps including:
(i) selecting at least one set of machine-based rules that embody guidelines for managing at least one medical condition and, if a plurality of sets have been selected, combining them into a single selected set; and
(ii) resolving any conflicts detected within the selected set of machine-based rules to form a conflict-resolved rule set, wherein the detected conflicts have been identified by computer-mediated interaction or analysis of the selected set of machine-based rules;
B. preparing and authoring a personalized treatment plan for at least one of said one or more individuals, by steps including:
(ii) receiving intake health data concerning the said at least one of said one or more individuals, and
(ii) processing said intake health data in a computer in accordance with said rules, to create said treatment plan; and
C. providing a computerized tool for interactive health management of said at least one of said one or more individuals in accordance with said personalized treatment plan.

59. A computer-assisted method for generating a treatment plan for health management of one or more individuals comprising the steps of:
A. authoring and publishing one or more sets of rules and protocols for preparing said treatment plan, by steps including:
(i) selecting at least one set of machine-based rules that embody guidelines for managing at least one medical condition and, if a plurality of sets have been selected, combining them into a single selected set;
(ii) resolving any conflicts detected within the selected set of machine-based rules to form a conflict-resolved rule set, wherein the detected conflicts have been identified by computer-mediated interaction or analysis of the selected set of machine-based rules; and
(iii) customizing the conflict-resolved rule set to form a set of treatment plan creation rules;
B. preparing and authoring a personalized treatment plan for at least one of said one or more individuals, by steps including:
(i) receiving intake health data concerning the said at least one of said one or more individuals, and
(ii) processing said intake health data in a computer in accordance with said rules, to create said treatment plan; and
C. providing a computerized tool for interactive health management of said at least one of said one or more individuals in accordance with said personalized treatment plan.

60. A computer-assisted method for generating a treatment plan for health management of one or more individuals comprising the steps of:
A. providing computerized instructions that enable an authoring institution to author and publish one or more sets of rules and protocols for preparing said treatment plan for health management of one or more individuals;
B. providing computerized instructions that enable a subscribing institution to select at least one of said one or more sets of rules and protocols and to apply clinical data concerning at least one of said one or more individuals in order to prepare and authorize a personalized treatment plan for health management of at least one of said one or more individuals; and
C. providing computerized instructions for interactive health management of at least one of said one or more individuals in accordance with a personalized treatment plan.

61. The computer-assisted method of any of claims 56-58 or 60, wherein step A includes the preparation of a conflict-resolved rule set and said conflict-resolved rule set is customized to form a set of treatment plan creation rules.

62. The computer-assisted method of any of claims 56-60, wherein step A. includes the use of a rule generator for blending rule sets.

63. The computer-assisted method of claim 60, wherein step A. further includes the use of rule conflict resolution techniques.

64. The computer-assisted method of any of claims 56-58 or 60, wherein step B. further includes the provision of customized treatment plan rules branded to reflect an approval of said authoring institution.

65. The computer-assisted method of any of claims 56-60, wherein step C. further includes provision of a monitoring function for monitoring at least one of said one or more individuals so as to provide benefits to a medical community.
